(19) United States
(12) Patent Application Publication
(10) Pub. No.: US 2018/0324620 A1
(43) Pub. Date: Nov. 8, 2018

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Zhiyu Zhang, Beijing (CN); Jing Wang, Beijing (CN); Liu Liu, Beijing (CN); Huiling Jiang, Beijing (CN)

(73) Assignee: NTT DOCOMO, INC., Tokyo (JP)

(21) Appl. No.: 15/772,930

(22) PCT Filed: Nov. 2, 2016
(86) PCT No.: PCT/JP2016/082504

§ 371 Date: May 2, 2018

(30) Foreign Application Priority Data
Nov. 5, 2015 (JP) 2015-218002

(51) Int. Cl. H04W 24/10; H04W 16/14

(52) U.S. Cl. CPC H04W 24/10; H04W 16/14

(57) ABSTRACT

The present invention is designed to implement adequate inter-frequency measurements in next-generation communication systems. According to one aspect of the present invention, a user terminal has a measurement section that performs an inter-frequency measurement based on one measurement gap configuration, and a control section that controls whether or not to perform the inter-frequency measurement in a predetermined measurement gap.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, the specifications of LTE-A (also referred to as LTE-advanced, LTE Rel. 10, 11 or 12) have been drafted for further broadbandization and increased speed beyond LTE (also referred to as LTE Rel. 8 or 9), and successor systems of LTE (also referred to as, for example, FRA (Future Radio Access), 5G (5th generation mobile communication system), LTE Rel. 13 and so on) are under study.

The specifications of Rel. 8 to 12 LTE have been drafted assuming exclusive operations in frequency bands that are licensed to operators—that is, licensed bands. As licensed bands, for example, 800 MHz, 2 GHz, 1.7 GHz and 2 GHz are used.

In recent years, user traffic has been increasing steeply following the spread of high-performance user terminals (UE: User Equipment) such as smart-phones and tablets. Although more frequency bands need to be added to meet this increasing user traffic, licensed bands have limited spectra (licensed spectra).

Consequently, a study is in progress with Rel. 13 LTE to enhance the frequencies of LTE systems by using bands of unlicensed spectra (also referred to as “unlicensed bands”) that are available for use apart from licensed bands (see non-patent literature 2). For unlicensed bands, for example, the 2.4 GHz band and the 5 GHz band, where Wi-Fi (registered trademark) and Bluetooth (registered trademark) can be used, are under study for use.

To be more specific, with Rel. 13 LTE, a study is in progress to execute carrier aggregation (CA) between licensed bands and unlicensed bands. Communication that is carried out by using unlicensed bands with licensed bands like this is referred to as “LAA” (License-Assisted Access). Note that, in the future, dual connectivity (DC) between licensed bands and unlicensed bands and stand-alone in unlicensed bands may become the subject of study under LAA.

For unlicensed bands in which LAA is run, a study is in progress to introduce interference control functionality in order to allow co-presence with other operators' LTE, Wi-Fi or different systems. In Wi-Fi, LBT (Listen Before Talk), which is based on CCA (Clear Channel Assessment), is used as an interference control function within the same frequency. LBT refers to the technique of “listening” (sensing) before transmitting signals, and controlling transmission based on the result of listening. For example, in Japan and Europe, the LBT function is stipulated as mandatory in systems that run in the 5 GHz unlicensed band such as Wi-Fi.

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2” Non-Patent Literature 2: AT&T, Drivers, Benefits and Challenges for LTE in Unlicensed Spectrum, 3GPP TSG-RAN Meeting #62 RP-131701

### SUMMARY OF INVENTION

### Technical Problem

In LAA, user terminals are expected to support inter-frequency measurements to measure RSRP (Reference Signal Received Power) and/or RSSI (Received Signal Strength Indicator) in cells (non-serving cells, non-serving carriers, etc.) that use different frequencies than the connecting unlicensed band cell (the serving cell, the serving carrier, etc.).

However, even if the techniques of inter-frequency measurements for licensed bands are applied to unlicensed bands on an as-is basis, there is a threat that RSRP and/or RSSI cannot be measured adequately in non-serving cells of unlicensed bands.

The present invention has been made in view of the above, and it is therefore an object of the present invention to provide a user terminal, a radio base station and a radio communication method whereby inter-frequency measurements can be carried out adequately in future radio communication systems.

### Solution to Problem

According to one aspect of the present invention, a user terminal has a measurement section that performs an inter-frequency measurement based on one measurement gap configuration, and a control section that controls whether or not to perform the inter-frequency measurement in a predetermined measurement gap.

### Advantageous Effects of Invention

According to the present invention, inter-frequency measurements can be carried out adequately in future radio communication systems.

### BRIEF DESCRIPTION OF DRAWINGS

FIG. 1A is a diagram to show an example gap pattern based on a given MG configuration, and FIG. 1B is a diagram to show gap patterns based on conventional MG configurations;

FIG. 2A is a diagram to show an example of an inter-frequency measurement scenario in LAA, and FIG. 2B is a diagram to show another example of an inter-frequency measurement scenario in LAA;

FIG. 3 is a diagram to show an example of conventional inter-frequency measurements using MGs;

FIG. 4 is a diagram to show an example of MG control to apply to scenario 1, in accordance with a first embodiment;

FIG. 5 is a diagram to show another example of MG control to apply to scenario 1, in accordance with the first embodiment;

FIG. 6 is a diagram to show an example of MG control to apply to scenario 2, in accordance with the first embodiment;

FIG. 7 is a diagram to show an example configuration to perform inter-frequency measurements;

FIG. 8A is a diagram to show an example of MG configuration to apply to the inter-frequency measurements executed in FIG. 7, and FIG. 8B is a diagram to show examples of the contents of inter-frequency measurements executed (or not executed) in each MG (MG1 to MG5) in FIG. 8A;

FIG. 9 is a diagram to show an example of MG control according to a second embodiment;

FIG. 10 is a diagram to show an example of conventional inter-frequency measurements for multiple carriers;

FIG. 11 is a diagram to show an example of inter-frequency measurements for multiple carriers according to a third embodiment;

FIG. 12 is a diagram to show an example of a schematic structure of a radio communication system according to an embodiment of the present invention;

FIG. 13 is a diagram to show an example of an overall structure of a radio base station according to an embodiment of the present invention;

FIG. 14 is a diagram to show an example of a functional structure of a radio base station according to one embodiment of the present invention;

FIG. 15 is a diagram to show an example of an overall structure of a user terminal according to an embodiment of the present invention;

FIG. 16 is a diagram to show an example of a functional structure of a user terminal according to an embodiment of the present invention;

FIG. 17 is a diagram to show an example hardware structure of a radio base station and a user terminal according to an embodiment of the present invention.

### DESCRIPTION OF EMBODIMENTS

In systems (for example, LAA systems) that run LTE/LTE-A in unlicensed bands, interference control functionality is likely to be necessary in order to allow co-presence with other operators' LTE, Wi-Fi, or other different systems. Note that, systems that run LTE/LTE-A in unlicensed bands may be collectively referred to as “LAA,” “LAA-LTE,” “LTE-U,” “U-LTE” and so on, regardless of whether the mode of operation is CA, DC or SA.

Generally speaking, when a transmission point (for example, a radio base station (eNB), a user terminal (UE) and so on) that communicates by using a carrier (which may also be referred to as a “carrier frequency,” or simply a “frequency”) of an unlicensed band detects another entity (for example, another UE) that is communicating in this unlicensed band carrier, the transmission point is disallowed to make transmission in this carrier.

So, the transmission point executes listening (LBT) at a timing that is a predetermined period ahead of a transmission timing. To be more specific, by executing LBT, the transmission point searches the whole of the target carrier band (for example, one component carrier (CC)) at a timing that is a predetermined period ahead of a transmission timing, and checks whether or not other devices (for example, radio base stations, UEs, Wi-Fi devices and so on) are communicating in this carrier band.

Note that, in the present description, “listening” refers to the operation which a given transmission point (for example, a radio base station, a user terminal, etc.) performs before transmitting signals in order to check whether or not signals to exceed a predetermined level (for example, predetermined power) are being transmitted from other transmission points. Also, this “listening” performed by radio base stations and/or user terminals may be referred to as “LBT,” “CCA,” “carrier sensing” and so on.

If it is confirmed that no other devices are communicating, the transmission point carries out transmission using this carrier. If the received power measured during LBT (the received signal power during the LBT period) is equal to or lower than a predetermined threshold, the carries out transmission. When a “channel is in the idle state,” this means that, in other words, the channel is not occupied by a specific system, and it is equally possible to say that a channel is “idle,” a channel is “clear,” a channel is “free,” and so on.

On the other hand, if only just a portion of the target carrier band is detected to be used by another device, the transmission point stops its transmission. For example, if the transmission point detects that the received power of a signal from another device entering this band exceeds a predetermined threshold, the transmission point judges that the channel is in the busy state (LBT_{busy}), and makes no transmission. In the event LBT_{busy} is yielded, LBT is carried out again with respect to this channel, and the channel becomes available for use only after it is confirmed that the channel is in the idle state. Note that the method of judging whether a channel is in the idle state/busy state based on LBT is by no means limited to this.

As LBT mechanisms (schemes), FBE (Frame Based Equipment) and LBE (Load Based Equipment) are currently under study. Differences between these include the frame configurations to use for transmission/receipt, the channel-occupying time, and so on. In FBE, the LBT-related transmitting/receiving configurations have fixed timings. Also, in LBE, the LBT-related transmitting/receiving configurations are not fixed in the time direction, and LBT is carried out on an as-needed basis.

To be more specific, FBE has a fixed frame period, and is a mechanism of carrying out transmission if the result of executing carrier sensing for a certain period (which may be referred to as “LBT duration” and so on) in a predetermined frame shows that a channel is available for use, and not making transmission but waiting until the next carrier sensing timing if no channel is available.

On the other hand, LBE refers to a mechanism for implementing the ECCA (Extended CCA) procedure of extending the duration of carrier sensing when the result of carrier sensing (initial CCA) shows that no channel is available for use, and continuing executing carrier sensing until a channel is available. In LBE, random backoff is required to adequately avoid contention.

Note that the duration of carrier sensing (also referred to as the “carrier sensing period”) refers to the time (for example, the duration of one symbol) it takes to gain one LBT result by performing listening and/or other processes and deciding whether or not a channel can be used.

A transmission point can transmit a predetermined signal (for example, a channel reservation signal) based on the result of LBT. Here, the result of LBT refers to information about the state of channel availability (for example, “LBT_{idle},” “LBT_{busy},” etc.), which is acquired by LBT in carriers where LBT is configured.

As described above, by introducing interference control for use within the same frequency that is based on LBT mechanisms to transmission points in LAA systems, it is possible to prevent interference between LAA and Wi-Fi, interference between LAA systems and so on. Furthermore, even when transmission points are controlled independently per operator that runs an LAA system, it is possible to reduce interference without learning the details of each operator's control, by means of LBT.

Also, in LAA systems, to configure and/or reconfigure unlicensed band SCells (Secondary Cells) for UEs, a UE has to detect SCells that are present in the surroundings, by means of RRM (Radio Resource Management) measurements, measure their received quality, and then send a report to the network. The signal for RRM measurements in LAA is under study based on the discovery reference signal (DRS) that is stipulated in Rel. 12.

Note that the signal for RRM measurements in LAA may be referred to as the “detection/measurement signal,” the “discovery reference signal” (DRS), the “discovery signal,” (DS), the “LAA DRS,” the “LAA DS” and so on. Also, an unlicensed band SCell may be referred to as, for example, an “LAA SCell.”

Similar to the Rel. 12 DS, the LAA DRS may be constituted by including at least one of a synchronization signal (PSS (Primary Synchronization Signal)/SSS (Secondary Synchronization Signal)), a cell-specific reference signal (CRS) and a channel state information reference signal (CSI-RS).

Also, the network (for example, radio base stations) can configure the DMTC (Discovery Measurement Timing Configuration) of the LAA DRS in user terminals per frequency. The DMTC contains information about the transmission period of the DRS (which may be also referred to as “DMTC periodicity” and so on), the offset of DRS measurement timings, and so on.

The DRS is transmitted per DMTC periodicity, in the DMTC duration. Here, according to Rel. 12, the DMTC duration is fixed to 6 ms. Also, the length of the DRS (which may be also referred to as the “DRS occasion,” the “DS occasion,” the “DRS burst,” the “DS burst” and so on) that is transmitted in the DMTC duration is between 1 ms and 5 ms. The LAA DS may be configured the same as in Rel. 12, or may be configured differently. For example, taking the time of LBT into account, the DRS occasion may be made 1 ms or shorter, or may be made 1 ms or greater.

In an unlicensed band cell, a radio base station executes listening (LBT) before transmitting the LAA DRS, and transmits the LAA DRS when LBT_{idle} is yielded. A user terminal learns the timings and the period of DRS occasions based on the DMTC reported from the network, and detects and/or measures the LAA DRS.

Now, in LAA, a study is in progress to enable a UE to support inter-frequency measurements to carry out measurements in non-serving carriers (unlicensed bands) that are apart from the connecting serving carrier (unlicensed band). In inter-frequency measurements, at least one of the reference signal received power (RSRP (Reference Signal Received Power), the received signal strength (RSSI (Received Signal Strength Indicator) and the reference signal received quality (RSRQ (Reference Signal Received Quality) is measured in non-serving carriers.

Here, RSRP refers to the desired signal's received power, which is measured by using, for example, the CRS, the DRS and so on. Also, RSSI refers to the total received power combining the desired signal's received power and the power of interference and noise. RSRQ is the ratio of RSRP to RSSI.

In measurement gaps (MGs), a UE switches the receiving frequency from the serving carrier to a non-serving carrier, and measures at least one of RSRP, RSSI and RSRQ by using, for example, the DRS. Here, a measurement gap refers to a period for carrying out an inter-frequency measurement, and, in this period, the UE stops receiving in the communicating carrier, and performs a measurement with respect to another frequency carrier.

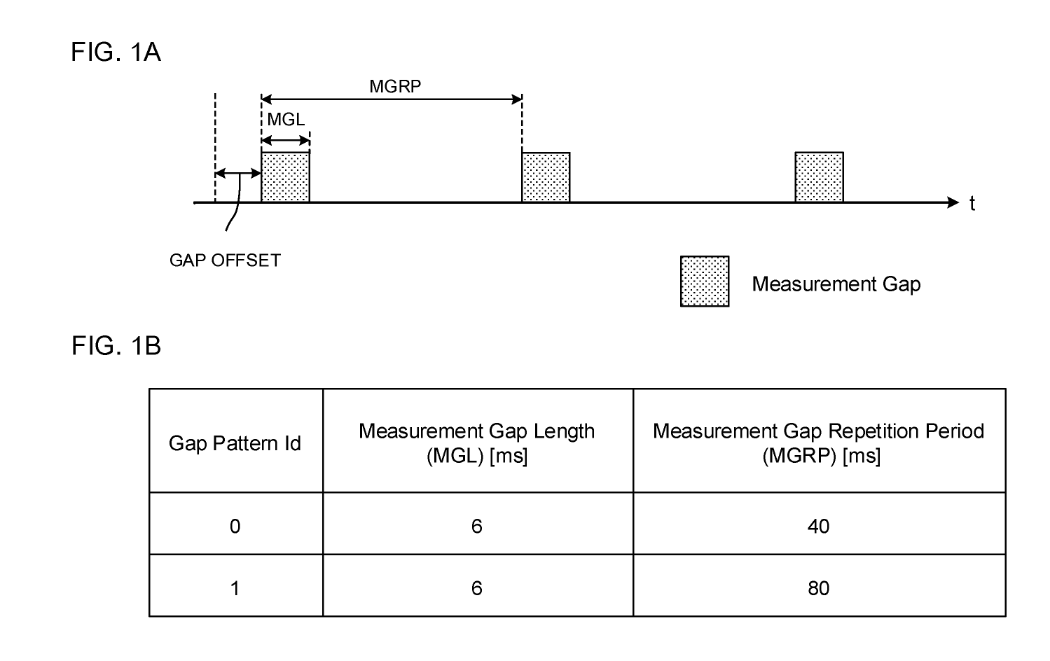

FIG. 1 provide diagrams to show examples of conventional MG configurations. FIG. 1A is a diagram to show an example gap pattern based on a given MG configuration. As shown in FIG. 1A, the UE uses a predetermined duration of time (also referred to as the “measurement gap length” (MGL)), which is repeated in a predetermined period (also referred to as the “measurement gap repetition period” (MGRP)), as an MG. The gap pattern is determined by MGL and MGRP. When the UE receives a gap pattern ID via higher layer signaling (for example, RRC signaling), the UE can specify the gap pattern based on this ID.

Also, in inter-frequency measurements, the gap offset may be reported via higher layer signaling (for example, RRC signaling). Here, as shown in FIG. 1A, the gap offset refers to the start offset from the top of a given radio frame to the beginning of an MG, and indicates the timing of the MG. Note that the UE may specify the gap pattern based on the gap offset that is reported. In this case, the gap pattern is reported implicitly.

As shown in FIG. 1B, in conventional LTE, two patterns—namely, gap pattern 0, in which MGL is 6 ms and MGRP is 40 ms, and gap pattern 1, in which MGL is 6 ms and MGRP is 80 ms—are defined. In licensed bands, conventional MG configurations such as these are likely to be used.

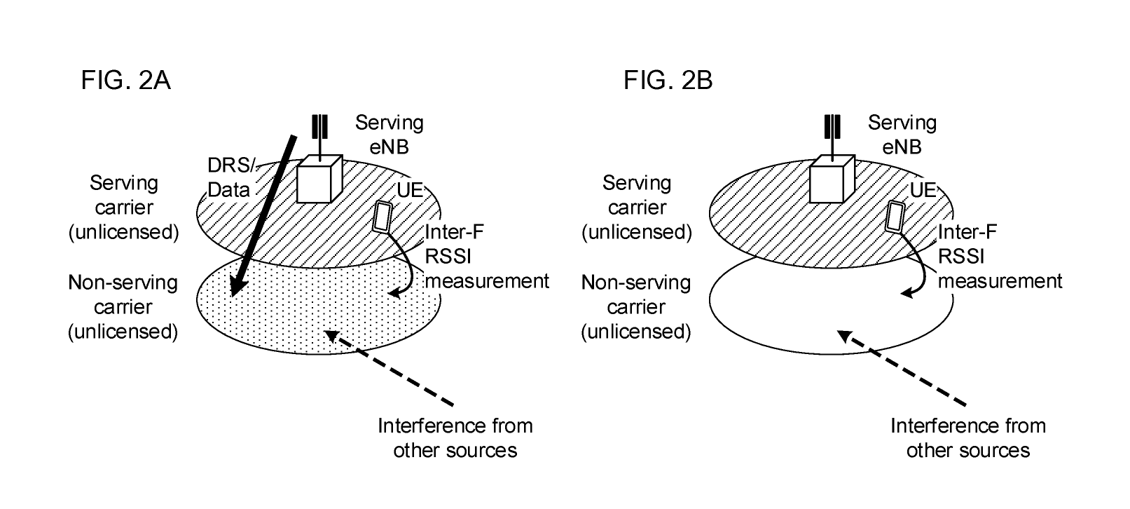

The UE performs RSSI measurements with respect to non-serving carriers in order to learn how much interference there is from sources apart from the serving eNB. FIG. 2 provide diagrams to show examples of inter-frequency measurement scenarios in LAA. When performing inter-frequency measurements (here, RSSI measurements) for non-serving carriers, the two scenarios shown in FIG. 2 are possible.

FIG. 2A illustrates the case where the serving eNB transmits signals (for example, data signal, DRS, etc.) in a non-serving carrier, which is the measurement target (hereinafter referred to as “scenario 1”). In scenario 1, interference from sources other than the serving eNB cannot be measured accurately in the non-serving carrier due to the signals transmitted from the serving eNB. The measurement results acquired thus do not adequately mirror the load profile of the non-serving carrier.

FIG. 2B illustrates the case where the serving eNB does not transmit signals in the measurement-target non-serving carrier (hereinafter referred to as “scenario 2”). In scenario 2, the non-serving carrier, suffering no impact from the serving eNB, can measure interference from sources other than the serving eNB accurately. The measurement results acquired thus adequately mirror the load profile of the non-serving carrier.

In view of the above, when inter-frequency RSSI measurements are to be performed with respect to LAA non-serving cells, the problem is that the timings, length and so on of the measurements have to be determined so that the environment fits scenario 2, not scenario 1.

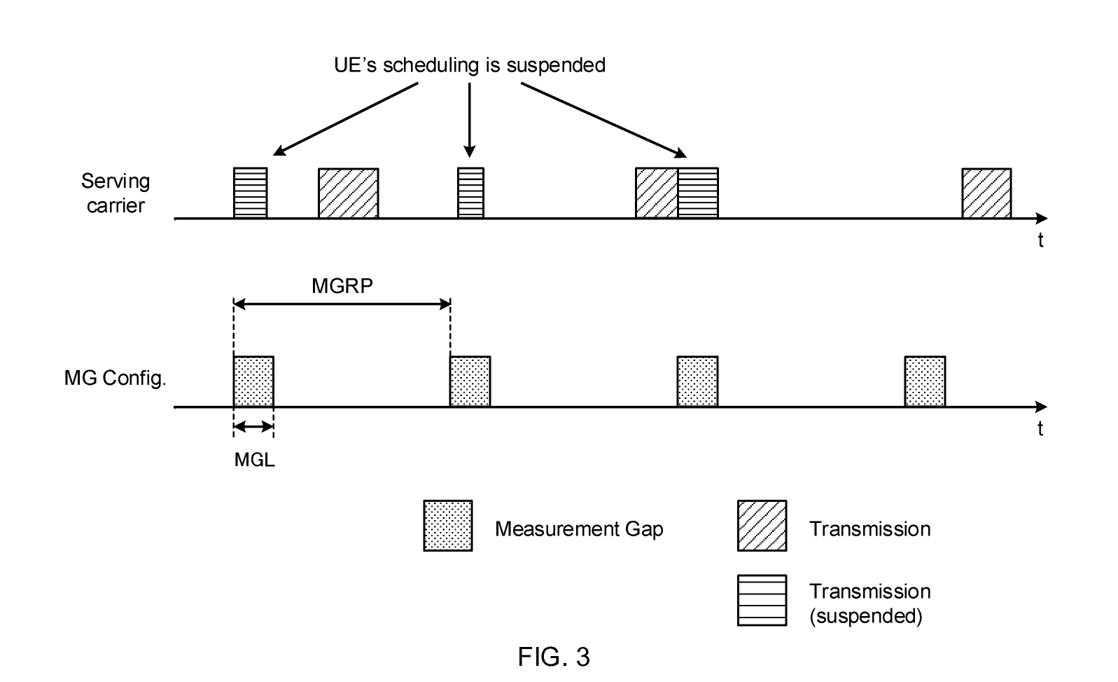

Also, in either scenario, there is also the problem that the scheduling for UEs in the serving carrier is suspended for a long period (stops temporarily). This will be explained with reference to FIG. 3. FIG. 3 is diagram to show an example of conventional inter-frequency measurements using MGs. FIG. 3 shows data transmission in the serving carrier and a gap pattern in a non-serving carrier.

Existing LTE systems are controlled so that measurements in MGs are executed preferentially over scheduling for UEs. FIG. 3 illustrates the situation where, in the serving carrier, the scheduling for UEs is suspended in periods that overlap MGs. Consequently, when MGs are configured in UEs, there is a threat that it takes an eNB a long time to succeed in scheduling, leading to a decrease in spectral efficiency.

So, the present inventors have come up with the idea of carrying out inter-frequency measurements by dynamically correcting semi-statically configured MG configurations. According to one examples of the present invention, it is possible to prevent communication in the serving carrier from being interrupted, reduce the loss of scheduling opportunities, and reduce the decrease of spectral efficiency.

Now, embodiments of the present invention will be described in detail below with reference to the accompanying drawings. Although examples will be described with each embodiment below where CA is executed assuming that the PCell (Primary Cell) is a licensed band and an SCell is an unlicensed band, this is by no means limiting.

That is, embodiments of the present invention can be configured so that a structure to make a licensed band (and the PCell) a carrier where listening (LBT) is not configured (which may also be referred to as a carrier that does execute LBT, a carrier that cannot execute LBT, and so on), and make an unlicensed band (and an SCell) a carrier where listening (LBT) is configured (which may also be referred to as a carrier that executes LBT, a carrier that should execute LBT, and so on) can be used in each embodiment.

Also, the combination of carriers where LBT is not configured and carriers where LBT is configured, and PCells and SCells is not limited to that given above. For example, the present invention is applicable to the case where a UE connects with an unlicensed band (a carrier where listening (LBT) is configured) in stand-alone.

(Radio Communication Method)

### First Embodiment

According to a first embodiment of the present invention, a UE controls whether or not to perform inter-frequency measurements based on predetermined downlink control information (DCI). To be more specific, based on information that is included in DCI to indicate whether an MG is valid/invalid, a UE determines whether to execute or not to execute (skip) a measurement in the MG after this DCI is received.

The MGs to be limited by this information may be only one MG that appears next right after the DCI is received, or may be part or all of the MGs included in a predetermined period. To see from the UE's perspective, whether or not to perform a measurement in a given MG can be determined based on the latest information that has been received to indicate whether an MG is valid/invalid.

For example, the information to indicate whether an MG is valid/invalid may be represented by one bit. In this case, ‘0’ represents that an MG is invalid and ‘1’ represents that an MG is valid, but these may be reversed. Note that this information may be represented by reading one of the bits in an existing DCI format as such, or may be represented by a bit defined in a new DCI format.

DCI to include the information that indicates whether an MG is valid/invalid is configured to be transmitted in at least one of a licensed carrier and an unlicensed carrier. The UE can judge whether an MG is valid/invalid based on the most recently received information that indicates whether an MG is valid/invalid. The information to indicate whether an MG is valid/invalid may be included in DCI for scheduling radio resources that overlap MGs, or may be included in DCI that is transmitted within a predetermined period before an MG starts.

An eNB includes the information to indicate whether an MG is valid/invalid in DCI and reports this to a UE. Here, in scenario 1, if signals (for example, data signal and/or DRS) are transmitted in an MG in at least one of the serving carrier with which the UE is connected and a carrier that is subject to inter-frequency measurements (non-serving carrier), the eNB includes information to indicate “invalid” in DCI and reports this. Also, if no signal is transmitted during an MG in the serving carrier or in the non-serving carrier, the eNB includes information to indicate “valid” in DCI and reports this.

Meanwhile, in scenario 2, if signals are transmitted in an MG in the serving carrier, the eNB includes information to indicate “invalid” in DCI and reports this. Also, if signals are not transmitted in an MG in the serving carrier, the eNB includes information to indicate “valid” in DCI and reports this.

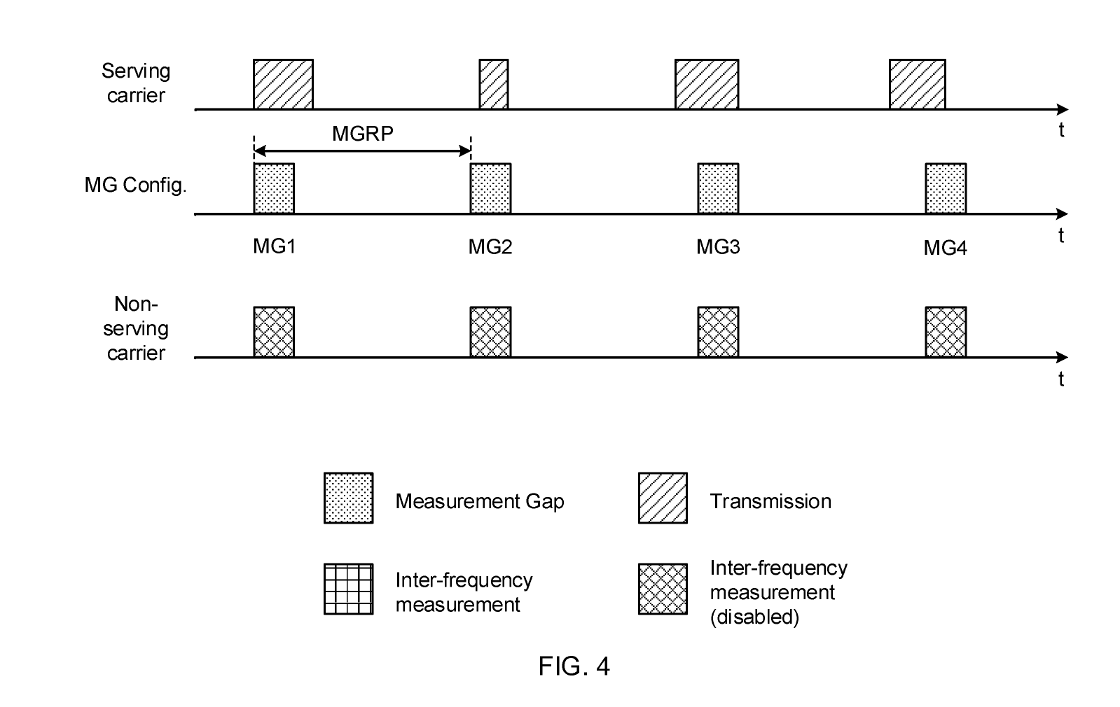

FIG. 4 is a diagram to show an example of MG control to apply to scenario 1 in accordance with the first embodiment. In FIG. 4, in the serving carrier, signal transmission is scheduled to overlap MGs (MG1 to MG4) that are arranged per MGRP (for example, 40 ms). In this case, before each MG starts, the serving eNB includes information to indicate that the MG is invalid in DCI, and reports this to a UE. The UE controls so that non-serving carrier measurements are not performed in any of the MGs.

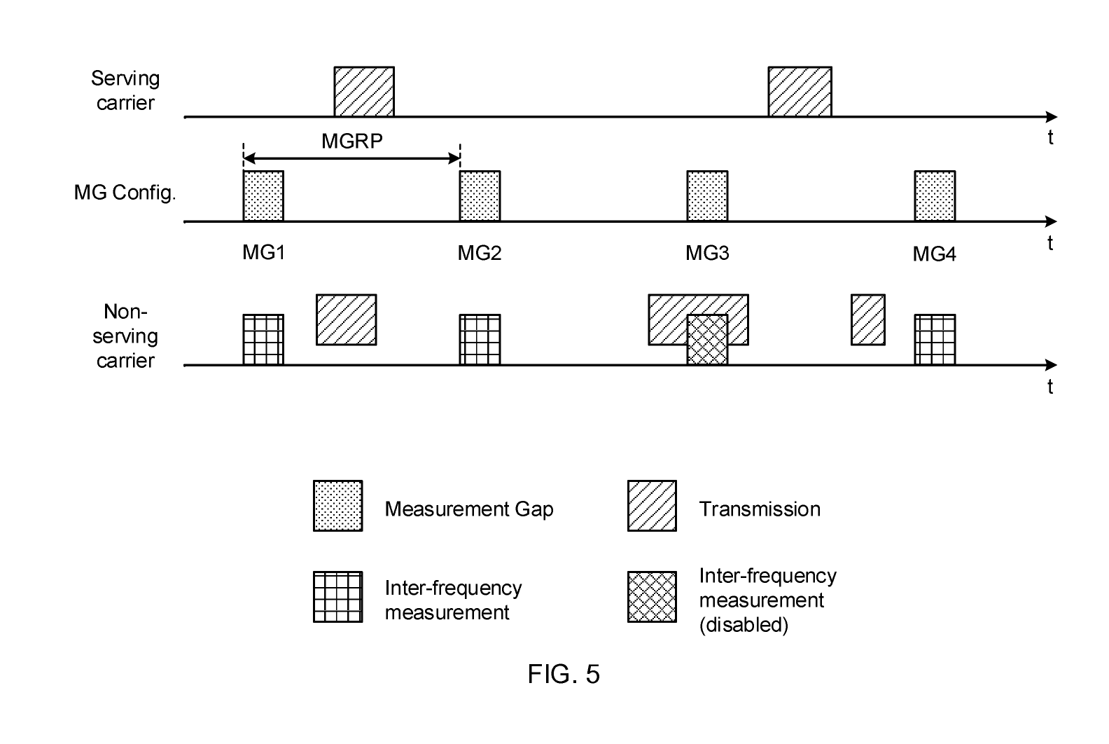

FIG. 5 is a diagram to show another example of MG control to apply to scenario 1 in accordance with the first embodiment. In FIG. 5, in the serving carrier, signal transmission is scheduled not to overlap MGs (MG1 to MG4) that are arranged per MGRP (for example, 40 ms). Meanwhile, in the non-serving carrier, signal transmission to overlap MG3 is scheduled.

In this case, before the MGs other than MG3 start, the serving eNB includes information to indicate that the MGs are valid in DCI, and reports this to the UE, and, before MG3 starts, the eNB includes information to indicate that the MG is invalid in DCI, and reports this. The UE controls so that a non-serving carrier measurement is performed in each MG, except for MG3.

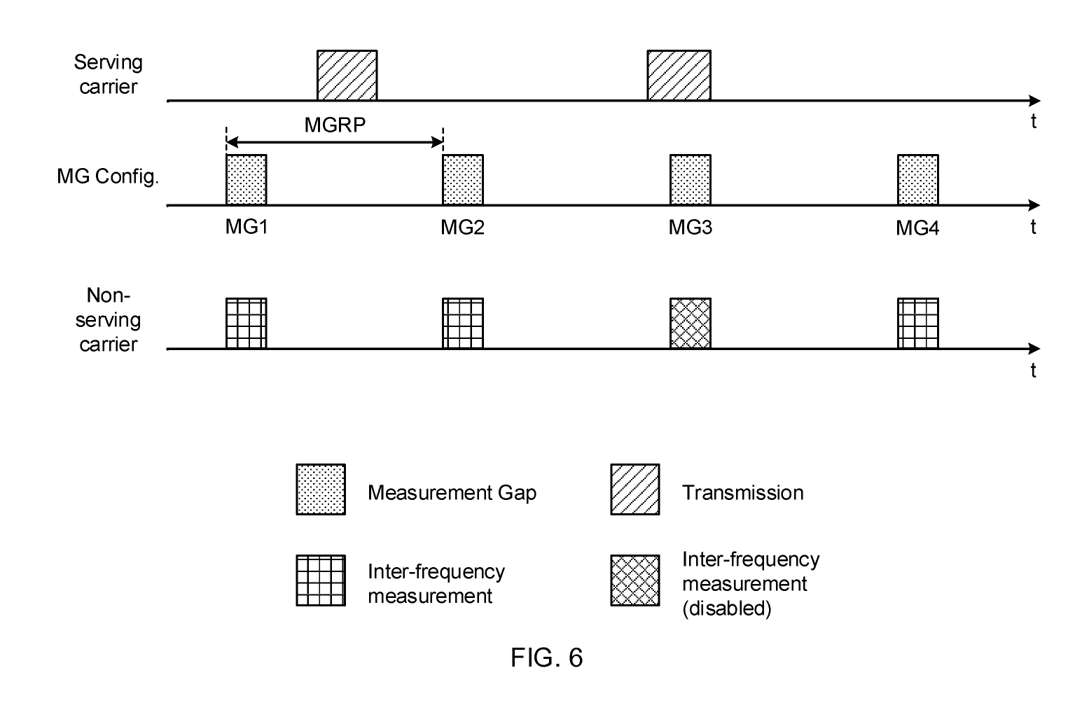

FIG. 6 is a diagram to show an example of MG control to apply to scenario 2 in accordance with the first embodiment. In FIG. 6, where MGs (MG1 to MG4) are arranged per MGRP (for example, 40 ms), signal transmission in the serving carrier is scheduled to overlap only MG3. Meanwhile, signal transmission is not scheduled in the non-serving carrier.

In this case, before the MGs other than MG3 start, the serving eNB includes information to indicate that the MGs are valid in DCI, and reports this to a UE, and, before MG3 starts, the eNB includes information to indicate that the MG is invalid in DCI, and reports this. The UE controls so that a non-serving carrier measurement is performed in each MG except for MG3.

### Variation of the First Embodiment

In Rel. 13 LTE, a configuration to carry out an RSSI measurement in a shorter time than 6 ms is under study. To be more specific, a study is in progress to make the time to perform an RSSI measurement minimum one OFDM (Orthogonal Frequency Division Multiplexing) symbol, and maximum 5 ms. By making the time of an RSSI measurement short, it is possible to avoid losing the opportunities for communication is the serving carrier to no purpose.

In order to support short-term RSSI measurements on a dynamic basis, the present inventors have conceived the following variations. When an eNB includes information to indicate whether an MG is valid/invalid in DCI, information about the length of measurement gaps (MGL) may be included in addition. In this case, for example, information to include one MGRP (for example, 40 ms) and MGL candidates is reported to a UE as an inter-frequency measurement MG configuration.

Here, an MGL candidate refers to an MGL that is specified by MGL information included in DCI. For example, when there are two MGL candidates of 6 ms and x ms (x<6), it is possible to make one predetermined bit of the DCI the MGL information so that the information indicates the first candidate (6 ms) when it is ‘1’ and indicates the second candidate (x ms) when it is ‘0.’

An MGL candidate that is shorter than 6 ms is suitable as the time for an RSSI measurement.

That is, the eNB can dynamically adjust the actual values of MGL and MGRP in different CCs by using two DCI bits. The information to indicate whether an MG is valid/invalid makes it possible to adjust MGRP in a CC where an MG appears right after DCI is received, and the MGL information makes it possible to adjust MGL in a CC where an MG appears right after DCI is received.

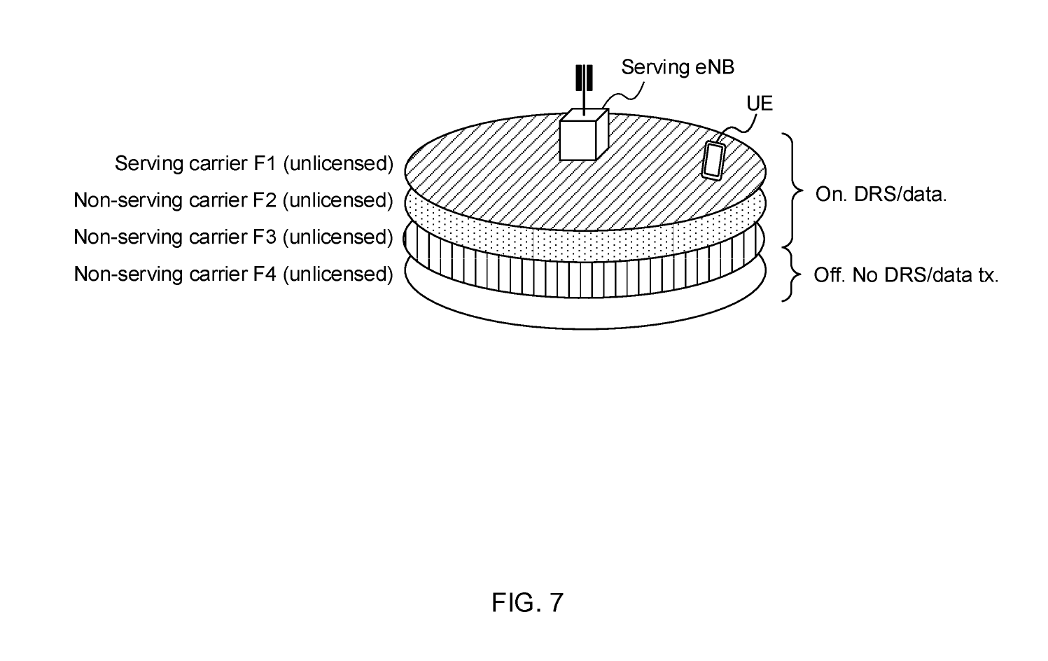

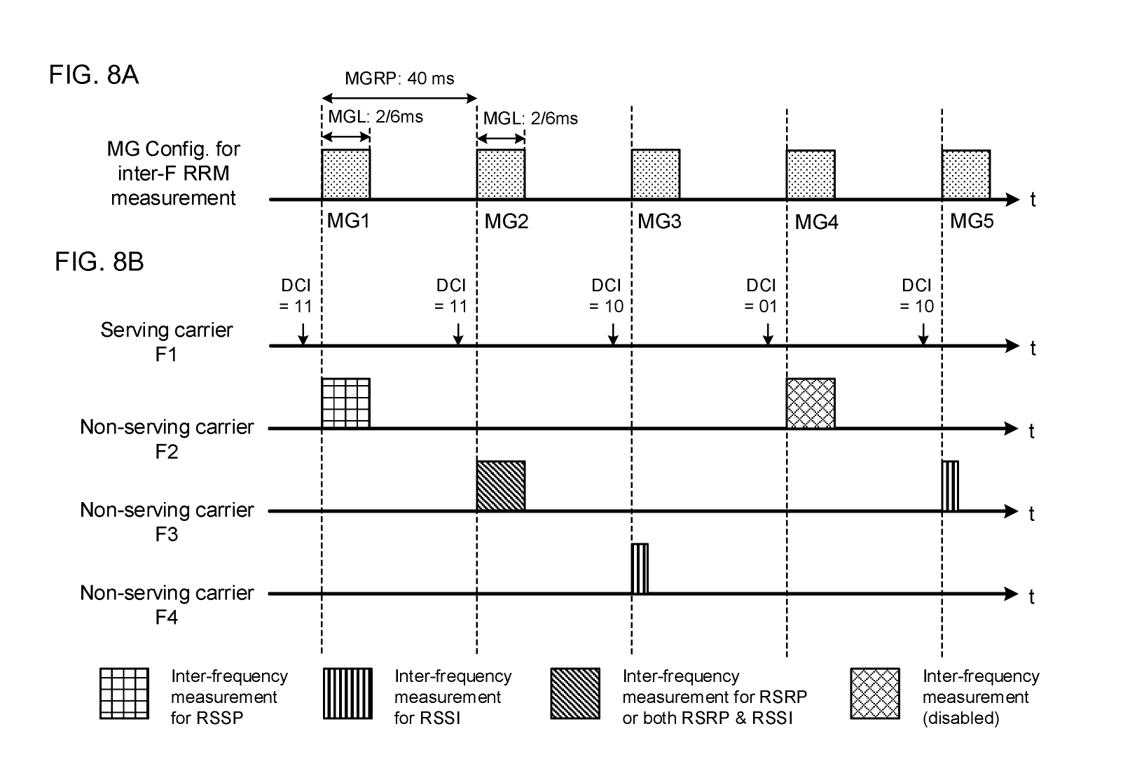

Now, specific examples of how inter-frequency measurements operate when information to indicate whether an MG is valid/invalid and information related to MGL are included in DCI will be described with reference to FIG. 7 and FIG. 8. FIG. 7 is a diagram to show an example configuration to perform inter-frequency measurements. FIG. 8 provide diagrams to show examples of how the MG control of the configuration of FIG. 7 is executed in variations of the first embodiment.

For example, referring to FIG. 7, the radio base station (serving eNB) is configured to be capable of communicating by using carriers F1 to F4 of varying frequencies in unlicensed bands. Carriers F1 to F3 are in the on state, in which DRS/data are transmitted and received. Carrier F4 is in the off state, in which DRS/data are not transmitted or received.

In FIG. 7, carrier F1 is configured as the serving carrier of a user terminal (UE). Meanwhile, carriers F2 to F4 are not configured as the UE's serving carriers. Also, the eNB configures the UE to perform inter-frequency RSRP measurements in carrier F2 and F3, and to perform inter-frequency RSSI measurements in carriers F3 and F4.

In FIG. 7, the UE is controlled to perform inter-frequency measurements based on the MG configuration shown in FIG. 8A. That is, in the UE, MGRP=40 ms and two MGL candidate (6 ms and 2 ms) are configured as an MG configuration.

FIG. 8B shows the contents of inter-frequency measurements executed (or not executed) in each MG (MG 1 to MG 5) in FIG. 8A. Note that, although, in FIG. 8B, the inter-frequency measurements in the MGs are carried out in the order of F2, F3, F4 and F2 and so on, this is by no means limiting. The UE receives, before each MG, DCI that includes two bits that represent information to indicate whether the MG is valid/invalid and information about MGL, in the serving carrier.

Given that an RSRP measurement is configured in F2, which is to be measured in MG1, and the above two DCI bits received before MG1 are “11,” the UE performs an RSRP measurement by using MGL=6 ms in MG1.

Given that an RSRP measurement and an RSSI measurement are configured in F3, which is to be measured in MG2, and the above two DCI bits received before MG2 are “11,” the UE performs both an RSRP measurement and an RSSI measurement by using MGL=6 ms in MG2. In this case, the UE may perform the RSRP measurement alone, instead of performing both measurements.

Given that an RSSI measurement is configured in F4, which is to be measured in MG3, and the above two DCI bits received before MG3 are “10,” the UE performs an RSSI measurement by using MGL=2 ms in MG3.

Although an RSRP measurement is configured in F2, which is to be measured in MG4, since the above two DCI bits received before MG4 are “01,” the UE performs no inter-frequency measurement in MG4.

Given that an RSRP measurement and an RSSI measurement are configured in F3, which is to be measured in MG5, and the above two DCI bits received before MG5 are “10,” the UE performs an RSSI measurement by using MGL=2 ms in MG5. In this way, in MGs in which the MGL is designated to be less than 6 ms, even if an RSRP measurement and an RSSI measurement are configured in a carrier, the UE can decide performing an RSSI measurement alone.

Note that although the examples of FIG. 7 and FIG. 8 shows cases where two MGL candidates are configured, this is by no means limiting. For example, three or more MGL candidates may be configured, and, in this case, the MGL information included in DCI may be formed with two or more bits.

Also, in another variation of the first embodiment, information about offset may be included in DCI, instead of the information that indicates whether an MG is valid/invalid. This information about offset represents the amount of shift to apply to the time the next (closest) MG starts. For example, if this information shows “1,” the UE shifts the next MG by 1 ms. Also, the information about offset ma assume arbitrary values (negative values, 0, positive values, etc.). By shifting MGs, it is possible to control MGs not to overlap signal transmissions in the serving carrier and/or non-serving carriers. Note that, with the information about offset, the information to indicate whether an MG is valid/invalid and/or the information about MGL may be included in DCI.

According to the above-described first embodiment, semi-statically configured MG configurations can be corrected on a dynamic basis, so that it is possible to prevent communication in the serving carrier from being interrupted, reduce the loss of scheduling opportunities, and reduce the decrease of spectral efficiency.

### Second Embodiment

A second embodiment of the present invention sets forth new UE operations for when MGs and scheduling in the serving carrier (data transmission and/or receipt). As has been described with FIG. 3, in existing LTE systems, a UE performs measurements using MGs, preferentially, over scheduling for the subject terminal. By contrast with this, with the second embodiment, a UE performs what is scheduled for the subject terminal, preferentially, over measurements that use MGs, except in certain examples, which will be described later.

For example, a UE may decide whether or not to perform an inter-frequency measurement in a given MG based on whether or not scheduling information (for example, a DL assignment (DL grant), a UL grant, etc.) to command at least one of transmission and receipt of data in the period that overlaps this MG is reported within a predetermined period (for example, N ms) before the MG. The above predetermined period may be, for example, 2 ms, 4 ms, or 6 ms.

When scheduling information to fulfill this condition is reported, the UE skips this MG (the inter-frequency measurement in this MG). On the other hand, if scheduling information to fulfill this condition is not reported, the UE performs an inter-frequency measurement in this MG.

Note that, when the above control is applied, cases might occur where an UE cannot perform inter-frequency measurements for a long period. To prevent such cases, when a UE skips inter-frequency measurements a predetermined number of times (for example, M times) in a row, the UE may controls to perform an inter-frequency measurement in the next MG even if scheduling to fulfill the above condition is reported for the next MG. Once the UE performs an inter-frequency measurement, the UE can reset (make 0) the number of times of skipping inter-frequency measurements, and resume the control to prioritize measurements that use MGs over scheduling. Note that the above predetermined number of times M may be, for example, 2, 4, 6 and so on.

The serving eNB, it self scheduling the UE, can recognize when the UE skips inter-frequency measurements a predetermined number of times in a row. Consequently, when the UE skips inter-frequency measurements a predetermined number of times in a row, it is preferable if the serving eNB makes no scheduling for the UE in the next MG.

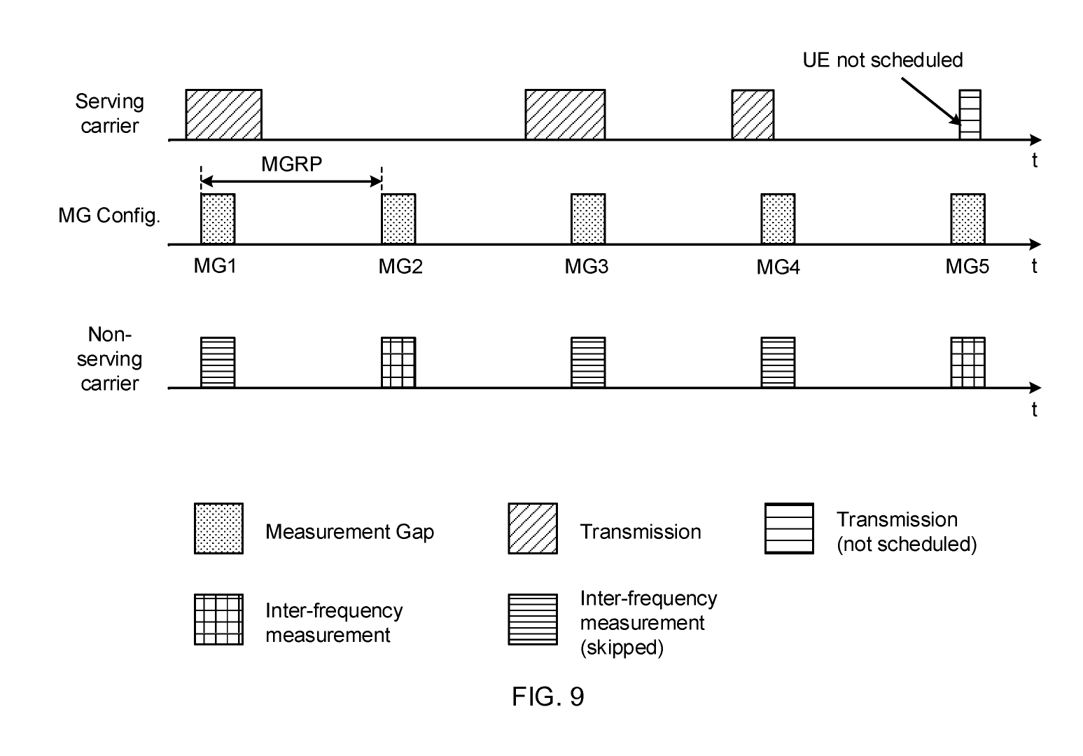

FIG. 9 is a diagram to show an example of MG control according to the second embodiment. FIG. 9 shows an example in which scheduling to overlap MGs is planned in MG1, MG3, MG4 and MG5. For ease of description, assume that the number of times inter-frequency measurements are skipped is 0 prior to MG1. Also, the following description will be given assuming that above-described M is M=2.

In MG1 where scheduling in the serving carrier overlaps, the UE skips the measurement of the non-serving carrier and transmits/receives data as scheduled.

In MG2 where scheduling in the serving carrier does not overlap, the UE performs a measurement for the non-serving carrier.

In MG3 and MG4 where scheduling in the serving carrier overlaps, the UE skips the measurement of the non-serving carrier, and transmits/receives data as scheduled.

Although scheduling in the serving carrier overlaps MG5, the UE, having already skipped inter-frequency measurements M times, performs a non-serving carrier measurement in MG5. The serving carrier does not have to schedule this UE in MG5.

According to the above-described second embodiment, it is possible to prioritize the communication in the serving carrier as much as possible, so that it is possible to reduce the decrease of spectral efficiency.

### Third Embodiment

A third embodiment of the present invention will show another method for coping with the problem of the overlap of MGs and scheduling, like one having been described with the second embodiment.

In conventional MG configurations, when a UE is configured to perform inter-frequency measurements in a plurality of carriers, the measurement period is the same in each carrier. For example, each carrier's measurement period can be calculated as (MGRP)×(the number of inter-frequency measurement target carriers).

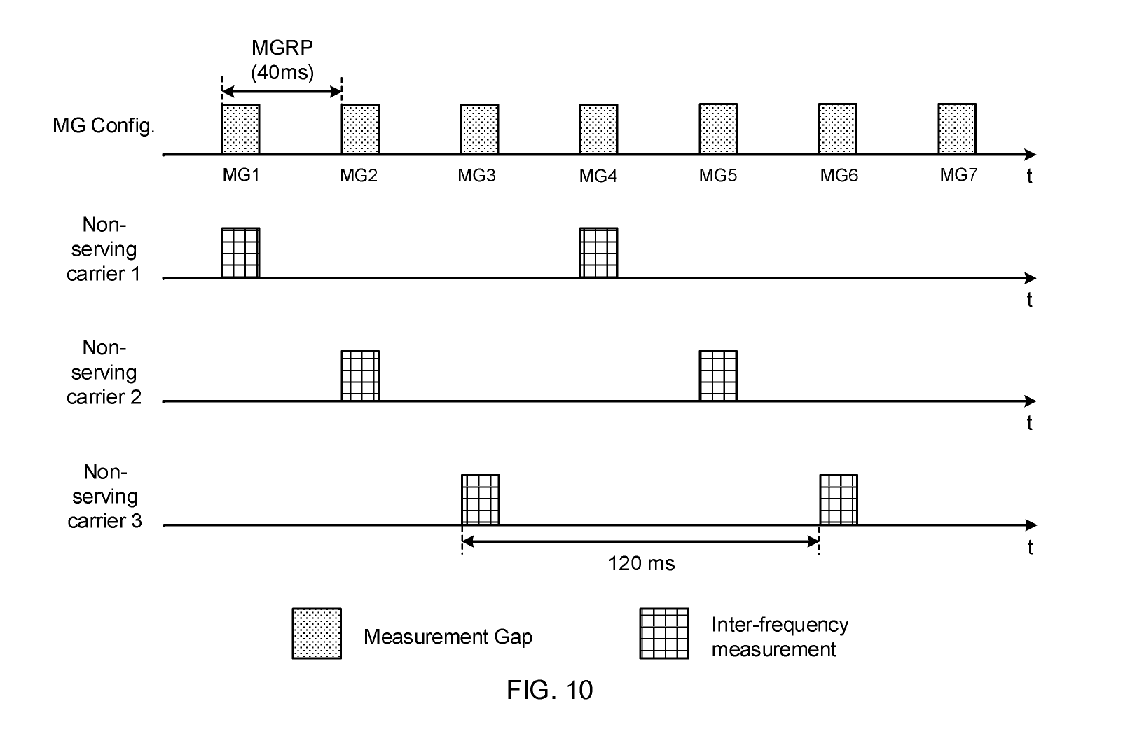

FIG. 10 is a diagram to show an example of conventional inter-frequency measurements for multiple carriers. In FIG. 10, three non-serving carriers are the measurement target and the MGRP is 40 ms, so that, in each carrier, the measurement period is 120 ms. In this way, conventional MG configurations are designed so that every MG is used to perform an inter-frequency measurement for one carrier, and therefore UEs cannot be scheduled in timings where MGs overlap, and this has a threat of leading to a decrease in spectral efficiency.

Also, the present inventors have focused on the point that the frequency measurements (for example, RSSI measurements) are required might vary per carrier. So, the present inventors have come up with a configuration that makes it possible to change the period of MGs on a per carrier (CC) basis, and arrived at the third embodiment. To be more specific, a UE controls whether or not to perform an inter-frequency measurement in each MG based on information about the measurement period of the carrier being the target of the inter-frequency measurement. This information about the measurement period may be referred to as “measurement period scaling information,” “scaling information,” and so on.

Here, this scaling information may be reported to the UE by using one of higher layer signaling (for example, RRC signaling) and downlink control information (for example, DCI) or by using a combination of these. For example, since the scaling information is CC-specific information, the scaling information may be included in the information element for configuring the measurement target (for example, MeasObjectEUTRA) in RRC configuration signaling (for example, RRC connection reconfiguration). Note that scaling information for a plurality of carriers may be reported together in RRC signaling.

The scaling information may be, for example, a scalar value, and referred to as “gapScalar.” The UE can use cycles that are determined by multiplying measurement periods that are calculated based on MGRP, the number of inter-frequency measurements target carriers and so on, as described above, by scalar values that are configured on a per carrier basis, as each carrier's measurement period.

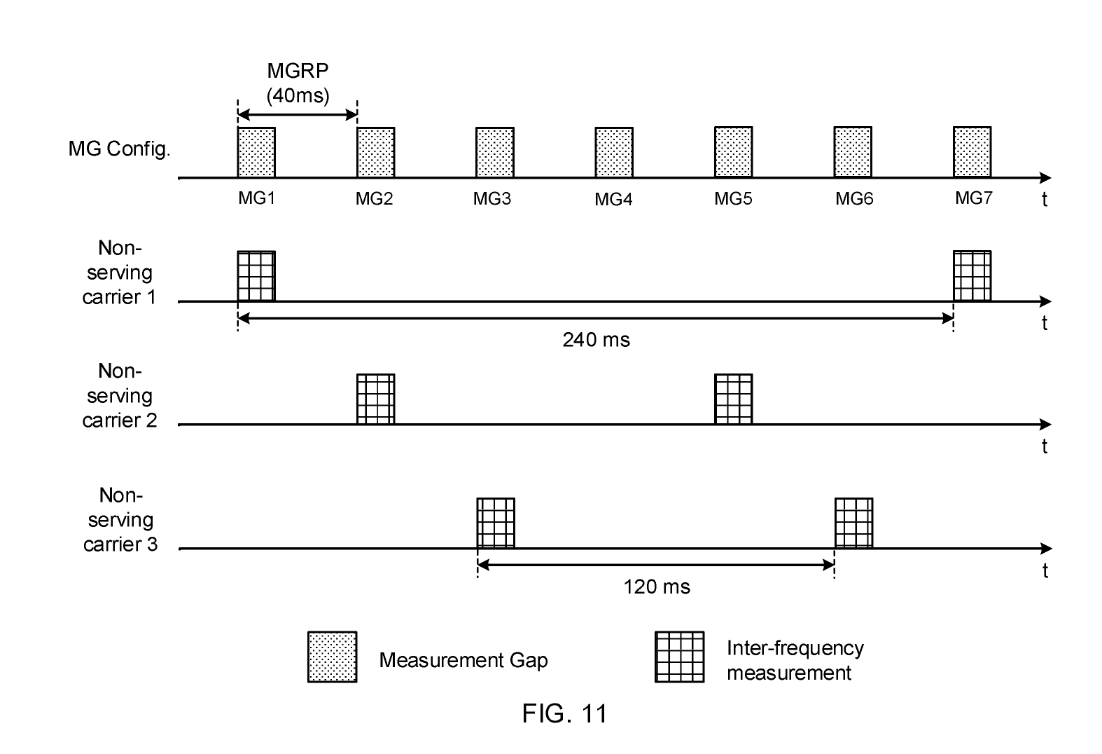

FIG. 11 is a diagram to show an example of inter-frequency measurements for multiple carriers according to the third embodiment. In FIG. 11, given that three non-serving carrier are the measurement target as in FIG. 10 and the MGRP is 40 ms, the measurement period of the carriers that would be calculated in conventional methods is 120 ms. Also, in each carrier, unique scaling information configured.

To be more specific, ‘2’ is configured in non-serving carrier 1, ‘1’ is configured in non-serving carrier 2 and ‘1’ is configured in non-serving carrier 3. In this case, as shown in FIG. 11A, the measurement period of non-serving carrier 1 is 120×2=240 ms and is different from 120 ms, which is the other non-serving carriers' measurement period. Consequently, according to the example, a UE does not perform an inter-frequency measurement for any of the non-serving carriers in MG4.

According to the above-described third embodiment, it is possible to secure time in which no inter-frequency measurement is performed, so that it is possible to prevent communication in the serving carrier from being interrupted, and, consequently, reduce the decrease of spectral efficiency.

<Variation>

Note that. although examples have been shown with each of the above-described embodiments in which a UE carries out inter-frequency measurements based on one MG configuration, the application of the present invention is by no means limited to this. For example, while it may be possible to configure a plurality of (for example, two) MG configurations for RSSP, RSSI and so on in a UE, in this case, it may be possible to correct at least one of the MG configurations on a dynamic basis, by using the above-described embodiments, and carry out inter-frequency measurements accordingly.

Also, when configurations that are different from existing MG configurations are set up in a UE, the present invention is still applicable. For example, even when an MG configurations that are different from the MG configurations shown in FIG. 1 (for example, a configuration in which the MGRP is shorter than 40 ms, the MGL is shorter than 6 ms, and so on) are applied, it is still possible to correct the MG configuration on a dynamic basis by using the above-described embodiments, and perform inter-frequency measurements accordingly.

(Radio Communication System)

Now, the structure of the radio communication system according to an embodiment of the present invention will be described below. In this radio communication system, the radio communication method according to one and/or a combination of the above-described embodiments of the present invention is employed.

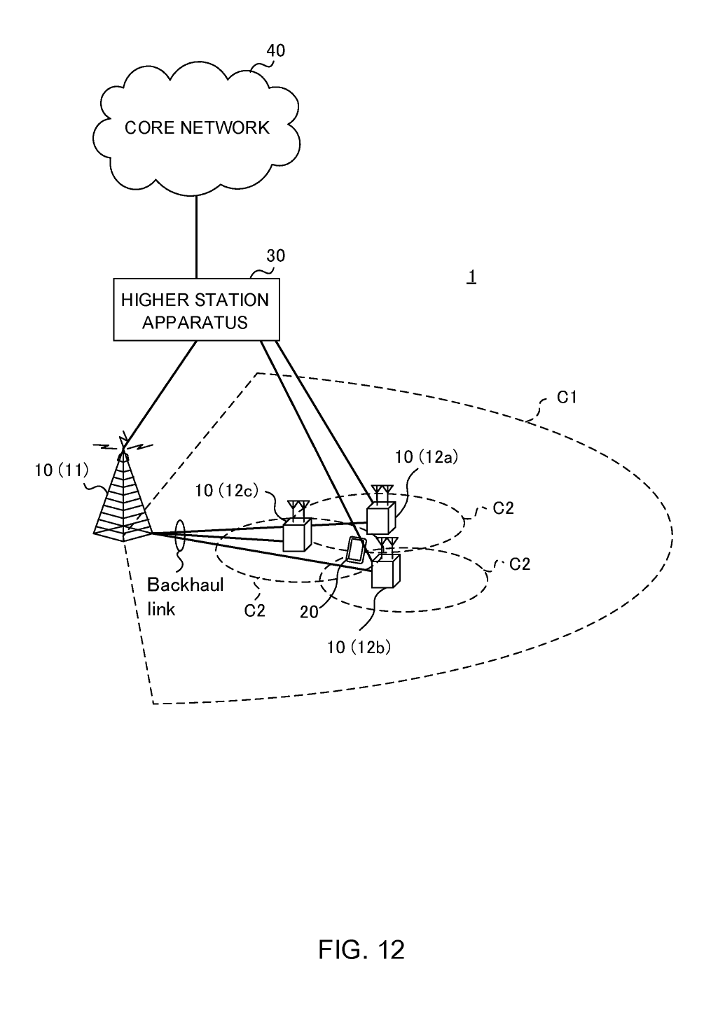

FIG. 12 is a diagram to show an example of a schematic structure of a radio communication system according to one embodiment of the present invention. The radio communication system 1 can adopt carrier aggregation (CA) and/or dual connectivity (DC) to group a plurality of fundamental frequency blocks (component carriers) into one, where the LTE system bandwidth constitutes one unit. Also, the radio communication system 1 has a radio base station (for example, an LTE-U base station) that is capable of using unlicensed bands.

Note that the radio communication system 1 may be referred to as “SUPER 3G,” “LTE-A,” (LTE-Advanced), “IMT-Advanced,” “4G” (4th generation mobile communication system), “5G” (5th generation mobile communication system), “FRA” (Future Radio Access) and so on.

The radio communication system 1 shown in FIG. 12 includes a radio base station 11 that forms a macro cell C1, and radio base stations 12 (12a to 12c) that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed band and the small cells C2 are used in unlicensed bands (LTE-U). Also, a mode may be also possible in which part of the small cells is used in a licensed band and the rest of the small cells are used in unlicensed bands.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (for example, the DL signal configuration) related to a radio base station 12 (which is, for example, an LTE-U base station) that uses an unlicensed band, from the radio base station 11 that uses a licensed band to the user terminals 20. Here, a structure may be employed in which, when CA is used between the licensed band and the unlicensed band, one of the radio base stations (for example, the radio base station 11) controls the scheduling of the licensed band cells and the unlicensed band cells.

Note that it is equally possible to use a structure in which a user terminal 20 connects with a radio base station 12, without connecting with the radio base station 11. For example, it is possible to use a structure in which a radio base station 12 that uses an unlicensed band connects with the user terminals 20 in stand-alone. In this case, the radio base station 12 controls the scheduling of unlicensed band cells.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the configuration of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as “radio base stations 10,” unless specified otherwise. Also, it is preferable to configure radio base stations 10 that use the same unlicensed band on a shared basis to be synchronized in time.

The user terminals 20 are terminals to support various communication schemes such as LTE, LTE-A and so on, and may be either mobile communication terminals or stationary communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, MIBs (Master Information Blocks) are communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. The PUSCH may be referred to as an uplink data channel. User data and higher layer control information are communicated by the PUSCH. Also, downlink radio quality information (CQI: Channel Quality Indicator), delivery acknowledgment information (ACKs/NACKs) and so on are communicated by the PUCCH. By means of the PRACH, random access preambles for establishing connections with cells are communicated.

In the radio communication systems 1, cell-specific reference signals (CRSs), channel state information reference signals (CSI-RSs), demodulation reference signal (DMRSs) and so on are communicated as downlink reference signals. Also, in the radio communication system 1, measurement reference signals (SRSs: Sounding Reference Signals), demodulation reference signals (DMRSs) and so on are communicated as uplink reference signals. Note that, the DMRSs may be referred to as user terminal-specific reference signals (UE-specific Reference Signals). Also, the reference signals to be communicated are by no means limited to these.

(Radio Base Station)

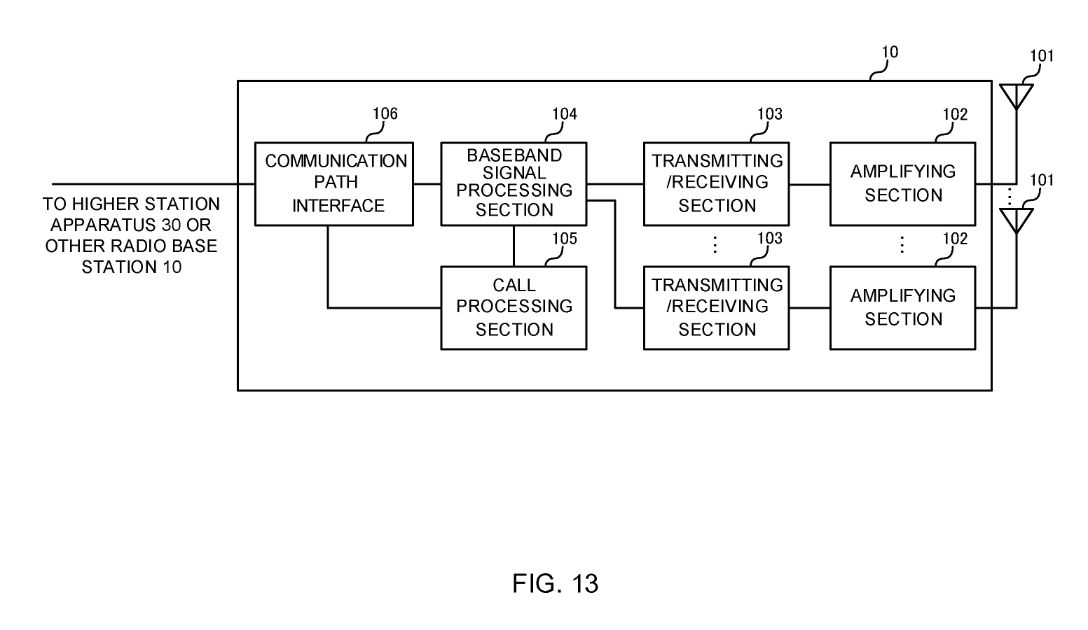

FIG. 13 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are pre-coded and output from the baseband signal processing section 104 on a per antenna basis are converted into a radio frequency band in the transmitting/receiving sections 103, and then transmitted. The radio frequency signals subjected to frequency conversion in the transmitting/receiving sections 103 are amplified in the amplifying sections 102, and transmitted from the transmitting/receiving antennas 101.

The transmitting/receiving sections 103 are capable of transmitting/receiving UL/DL signals in unlicensed bands. Note that the transmitting/receiving sections 103 may be capable of transmitting/receiving UL/DL signals in licensed bands as well. The transmitting/receiving sections 103 can be constituted by transmitters/receivers, transmitting/receiving circuits or transmitting/receiving devices that can be described based on common understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (for example, an interface in compliance with the CPRI (Common Public Radio Interface)m such as optical fiber, the X2 interface).

Note that the transmitting/receiving sections 103 transmit downlink signals to the user terminal 20 by using at least an unlicensed band. For example, the transmitting/receiving sections 103 transmit a DRS, which includes CSI-RSs that are frequency-multiplexed with the PSS/SSS, to the user terminals 20, in an unlicensed band, in a DMTC duration that is configured in the user terminals 20. Also, the transmitting/receiving sections 103 transmit DCI that includes at least one of scheduling information, information to indicate whether an MG is valid/invalid, information about MGL and information about offset, RRC signaling in which information about CC-specific measurement periods is included, and so on.

The transmitting/receiving sections 103 may receive non-serving carrier RRM measurement results (for example, CSI feedback and/or the like), from the user terminals 20, in a licensed band and/or an unlicensed band.

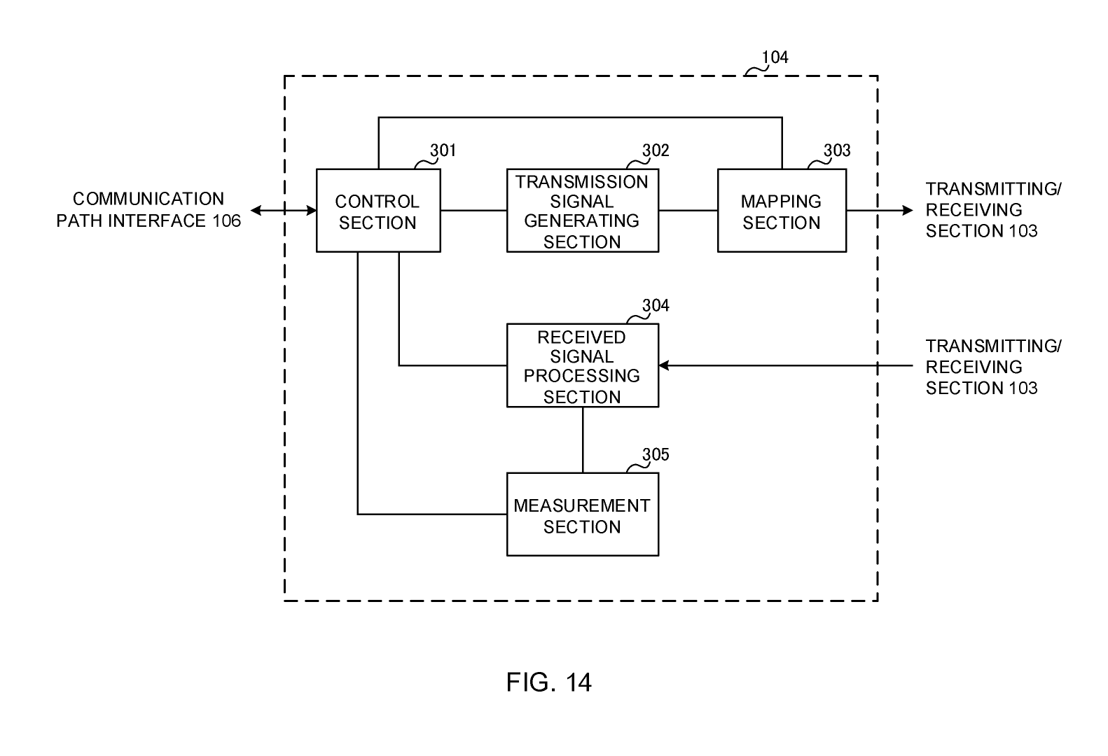

FIG. 14 is a diagram to show an example of a functional structure of a radio base station according to one embodiment of the present invention. Note that, although FIG. 14 primarily shows functional blocks that pertain to characteristic parts of the present embodiment, the radio base station 10 has other functional blocks that are necessary for radio communication as well. As shown in FIG. 14, the baseband signal processing section 104 has a control section (scheduler) 301, a transmission signal generating section 302, a mapping section 303, a received signal processing section 304 and a measurement section 305.

The control section (scheduler) 301 controls the whole of the radio base station 10. Note that, when a licensed band and an unlicensed band are scheduled with one control section (scheduler) 301, the control section 301 controls communication in the licensed band cells and the unlicensed band cells. For the control section 301, a controller, a control circuit or a control device that can be described based on common understanding of the technical field to which the present invention pertains can be used.

The control section 301, for example, controls the generation of signals in the transmission signal generating section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling (for example, resource allocation) of downlink data signals that are transmitted in the PDSCH and downlink control signals that are communicated in the PDCCH and/or the EPDCCH. Also, the control section 301 controls the scheduling of downlink reference signals such as synchronization signals (the PSS (Primary Synchronization Signal) and the SSS (Secondary Synchronization Signal)), the CRS, the CSI-RS, the DM-RS and so on.

Also, the control section 301 controls the scheduling of uplink data signals transmitted in the PUSCH, uplink control signals transmitted in the PUCCH and/or the PUSCH (for example, delivery acknowledgement signals (HARQ-ACKs)), random access preambles transmitted in the PRACH, uplink reference signals and so on.

The control section 301 controls the transmission of downlink signals in the transmission signal generating section 302 and the mapping section 303 in accordance with the results of LBT acquired in the measurement section 305. To be more specific, to control the DRS (LAA DRS) that has been described with the first, the second or the third embodiment to be transmitted in unlicensed bands, the control section 301 controls the generation, mapping, transmission and so on of each signal included in the DRS.

Also, the control section 301 may controls so that an MG configuration to allow a predetermined user terminal 20 to perform inter-frequency measurements (RRM measurements, RSRP measurements, RSSI measurements, etc.) in an unlicensed band is generated and transmitted.

Also, the control section 301 may have the results of inter-frequency measurements acquired in this predetermined user terminal 20 (for example, the received power, the received signal strength, the received power, channel states, etc.) and use these in control (scheduling and so on).

The transmission signal generating section 302 generates downlink signals (downlink control signals, downlink data signals, downlink reference signals and so on) based on commands from the control section 301, and outputs these signals to the mapping section 303. The transmission signal generating section 302 can be constituted by a signal generator, a signal generating circuit or a signal generating device that can be described based on common understanding of the technical field to which the present invention pertains.

For example, the transmission signal generating section 302 generates DL assignments, which report downlink signal allocation information, and UL grants, which report uplink signal allocation information, based on commands from the control section 301. Also, the downlink data signals are subjected to the coding process, the modulation process and so on, by using coding rates and modulation schemes that are determined based on, for example, channel state information (CSI: Channel State Information) reported from each user terminal. Also, the transmission signal generating section 302 generates a DRS that includes a PSS, an SSS, a CRS, a CSI-RS and so on.

The mapping section 303 maps the downlink signals generated in the transmission signal generating section 302 to predetermined radio resources based on commands from the control section 301, and outputs these to the transmitting/receiving sections 103. The mapping section 303 can be constituted by a mapper, a mapping circuit or a mapping device that can be described based on common understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). The received signal processing section 304 can be constituted by a signal processor, a signal processing circuit or a signal processing device that can be described based on common understanding of the technical field to which the present invention pertains.

The received signal processing section 304 outputs the decoded information acquired through the receiving processes to the control section 301. For example, when a PUCCH to contain an HARQ-ACK is received, the received signal processing section 304 outputs this HARQ-ACK to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or a measurement device that can be described based on common understanding of the technical field to which the present invention pertains.

The measurement section 305 executes LBT in a carrier where LBT is configured (for example, an unlicensed band) based on commands from the control section 301, and outputs the results of LBT (for example, judgments as to whether the channel state is idle or busy) to the control section 301.

Also, the measurement section 305 may measure, for example, the received power (for example, RSRP (Reference Signal Received Power)), the received signal strength (for example, RSSI (Received Signal Strength Indicator)), the received quality (for example, RSRQ (Reference Signal Received Quality)) and the channel states of the received signals. The measurement results may be output to the control section 301.

(User Terminal)

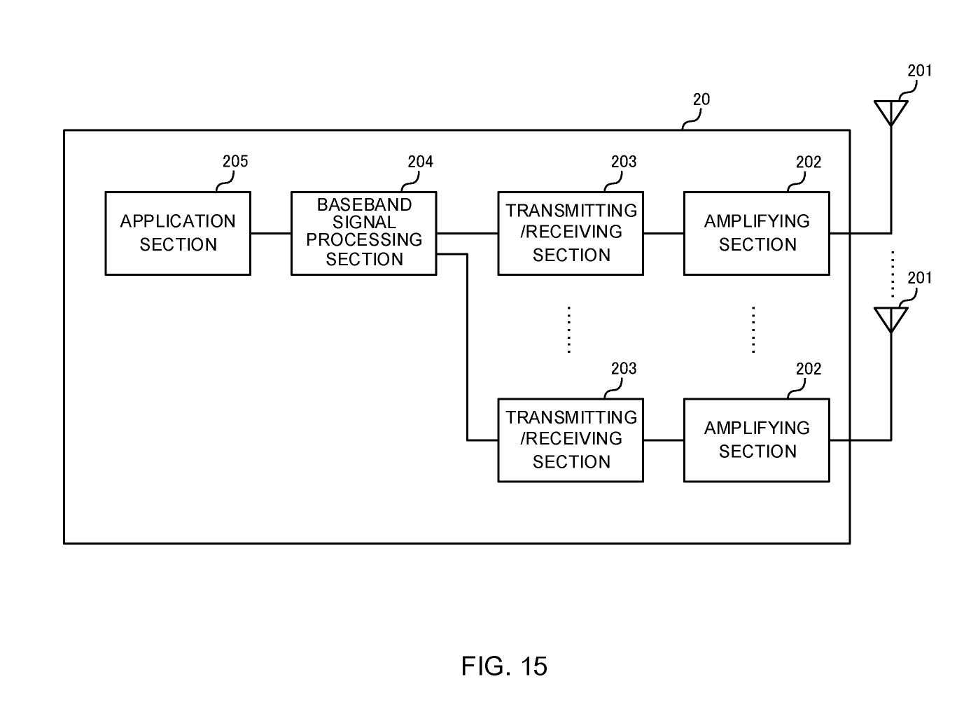

FIG. 15 is a diagram to show an example of an overall structure of a user terminal according to one embodiment of the present invention. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204. The transmitting/receiving sections 203 are capable of transmitting/receiving UL/DL signals in unlicensed bands. Note that the transmitting/receiving sections 203 may be capable of transmitting/receiving UL/DL signals in licensed bands as well.

The transmitting/receiving sections 203 can be constituted by transmitters/receivers, transmitting/receiving circuits or transmitting/receiving devices that can be described based on common understanding of the technical field to which the present invention pertains. Note that a transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 receive downlink signals transmitted from the radio base station 10, by using at least an unlicensed band. For example, the transmitting/receiving sections 203 receive a DRS, which includes CSI-RSs that are frequency-multiplexed with the PSS/SSS, in an unlicensed band, in a DMTC duration that is configured by the radio base station 10. Also, the transmitting/receiving sections 203 receive DCI that includes at least one of scheduling information, information to indicate whether an MG is valid/invalid, information about MGL and information about offset, RRC signaling in which information about CC-specific measurement periods is included, and so on.

Also, the transmitting/receiving sections 203 transmit uplink signals to the radio base station 10 by using at least one of a licensed band and an unlicensed band. For example, the transmitting/receiving sections 203 may transmit RRM measurements results (for example, the RSRP, RSSI, RSRQ and CSI feedback with respect to a non-serving carrier) in a licensed band and/or an unlicensed band.

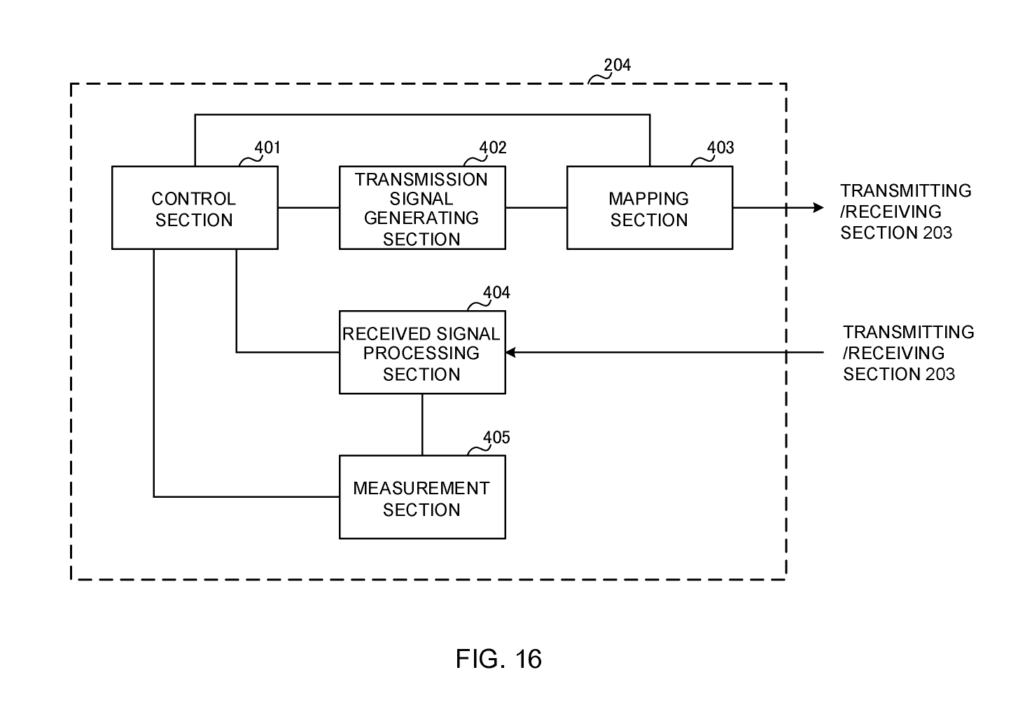

FIG. 16 is a diagram to show an example of a functional structure of a user terminal according to one embodiment of the present invention. Note that, although FIG. 16 primarily shows functional blocks that pertain to characteristic parts of the present embodiment, the user terminal 20 has other functional blocks that are necessary for radio communication as well. As shown in FIG. 16, the baseband signal processing section 204 provided in the user terminal 20 at least has a control section 401, a transmission signal generating section 402, a mapping section 403, a received signal processing section 404 and a measurement section 405.

The control section 401 controls the whole of the user terminal 20. The control section 401 can be constituted by a controller, a control circuit or a control device that can be described based on common understanding of the technical field to which the present invention pertains.

The control section 401, for example, controls the generation of signals in the transmission signal generating section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on.

The control section 401 may control the received signal processing section 404 and the measurement section 405 to perform RRM measurements and cell search by using DRSs (LAA DRSs) in unlicensed bands. Furthermore, the control section 401 may control the transmission signal generating section 402 and the mapping section 403 to transmit uplink signals based on LBT results acquired in the measurement section 405.

Also, the control section 401 may control the received signal processing section 404 and/or the measurement section 405 to perform inter-frequency measurements (RRM measurements, RSRP measurements, RSSI measurements, etc.), in an unlicensed band, based on MG configurations reported from the radio base station 10.

To be more specific, the control section 401 judges whether or not an inter-frequency measurement can be executed, for each MG that is specified by semi-static MG configurations, by using the radio communication methods having been described above with the first, second and third embodiments. For example, the control section 401 may control whether or not to perform an inter-frequency measurement in a predetermined MG based on at least one of information that indicate whether an MG is valid/invalid, information about MGL and information about offset, included in DCI.

Also, the control section 401 may control whether or not to perform an inter-frequency measurement in a predetermined MG based on scheduling information (for example, a DL grant, a UL grant, etc.).

Also, the control section 401 may control whether or not to perform an inter-frequency measurement in a predetermined MG based on information about CC-specific measurement periods, which is reported in RRC signaling.

Also, the control section 401 may have the results (for example, the received power, the received signal strength, the received quality, the channel states, etc.) measured in the measurement section 405 by using, for example, reference signals (for example, CRS, CSI-RS and so on), generate feedback information (for example, CSI), and transmit this to the radio base station 20. The results may be the results of inter-frequency measurements in non-serving carriers.

The transmission signal generating section 402 generates uplink signals (uplink control signals, uplink data signals, uplink reference signals and so on) based on commands from the control section 401, and outputs these signals to the mapping section 403. The transmission signal generating section 402 can be constituted by a signal generator, a signal generating circuit or a signal generating device that can be described based on common understanding of the technical field to which the present invention pertains.

For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

The mapping section 403 maps the uplink signals generated in the transmission signal generating section 402 to radio resources based on commands from the control section 401, and output the result to the transmitting/receiving sections 203. The mapping section 403 can be constituted by a mapper, a mapping circuit or a mapping device that can be described based on common understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains. Also, the received signal processing section 404 can constitute the receiving section according to the present invention.

The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. The measurement section 405 can be constituted by a measurer, a measurement circuit or a measurement device that can be described based on common understanding of the technical field to which the present invention pertains.

The measurement section 405 may execute LBT in carriers where LBT is configured (for example, a carrier in which listening is executed before signals are transmitted, and an unlicensed band is an example) based on commands from the control section 401. The measurement section 405 may output the results of LBT (for example, judgments as to whether the channel state is idle or busy) to the control section 401.

Also, the measurement section 405 may measure the received power (for example, RSRP), the received signal strength (RSSI), the received quality (for example, RSRQ) and the channel states and so on of the received signals. For example, the measurement section 405 performs RRM measurements of the LAA DRS. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be implemented with one physically-integrated device, or may be implemented by connecting two physically-separate devices via radio or wire and using these multiple devices.

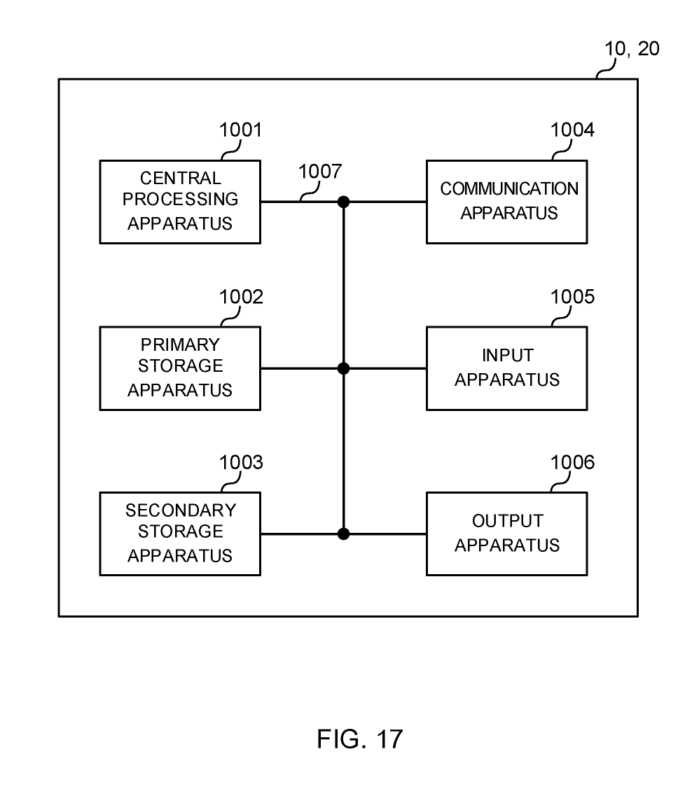

That is, a radio base station, a user terminal and so on according to an embodiment of the present invention may function as a computer that executes the processes of the radio communication method of the present invention. FIG. 17 is a diagram to show an example hardware structure of a radio base station and a user terminal according to an embodiment of the present invention. Physically, a radio base station 10 and a user terminal 20, which have been described above, may be formed as a computer apparatus that includes a central processing apparatus (processor) 1001, a primary storage apparatus (memory) 1002, a secondary storage apparatus 1003, a communication apparatus 1004, an input apparatus 1005, an output apparatus 1006 and a bus 1007. Note that, in the following description, the word “apparatus” may be replaced by “circuit,” “device,” “unit” and so on.

Each function of the radio base station 10 and user terminal 20 is implemented by reading predetermined software (programs) on hardware such as the central processing apparatus 1001, the primary storage apparatus 1002 and so on, and controlling the calculations in the central processing apparatus 1001, the communication in the communication apparatus 1004, and the reading and/or writing of data in the primary storage apparatus 1002 and the secondary storage apparatus 1003.

The central processing apparatus 1001 may control the whole computer by, for example, running an operating system. The central processing apparatus 1001 may be formed with a processor (CPU: Central Processing Unit) that includes a control apparatus, a calculation apparatus, a register, interfaces with peripheral apparatus, and so on. For example, the above-described baseband signal process section 104 (204), call processing section 105 and so on may be implemented by the central processing apparatus 1001.

Also, the central processing apparatus 1001 reads programs, software modules, data and so on from the secondary storage apparatus 1003 and/or the communication apparatus 1004, into the primary storage apparatus 1002, and executes various processes in accordance with these. As for the programs, programs to allow the computer to execute at least part of the operations of the above-described embodiments may be used. For example, the control section 401 of the user terminal 20 may be stored in the primary storage apparatus 1002 and implemented by a control program that runs on the central processing apparatus 1001, and other functional blocks may be implemented likewise.

The primary storage apparatus (memory) 1002 is a computer-readable recording medium, and may be constituted by, for example, at least one of a ROM (Read Only Memory), an EPROM (Erasable Programmable ROM), a RAM (Random Access Memory) and so on. The secondary storage apparatus 1003 is a computer-readable recording medium, and may be constituted by, for example, at least one of a flexible disk, an opto-magnetic disk, a CD-ROM (Compact Disc ROM), a hard disk drive and so on.

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, etc.). The output apparatus 1006 is an output device for allowing sending output to the outside (for example, a display, a speaker, etc.). Note that the input apparatus 1005 and the output apparatus 1006 may be provided in an integrated structure (for example, a touch panel).

Also, the apparatuses, including the central processing apparatus 1001, the primary storage apparatus 1002 and so on, may be connected via a bus 1007 to communicate information with each other. The bus 1007 may be formed with a single bus, or may be formed with buses that vary between the apparatuses. Note that the hardware structure of the radio base station 10 and the user terminal 20 may be designed to include one or more of each apparatus shown in the drawings, or may be designed not to include part of the apparatuses.

For example, the radio base station 10 and the user terminal 20 may be structured to include hardware such as an ASIC (Application-Specific Integrated Circuit), a PLD (Programmable Logic Device), an FPGA (Field Programmable Gate Array) and so on, and part or all of the functional blocks may be implemented by the hardware.

Note that the terminology used in this description and the terminology that is needed to understand this description may be replaced by other term s that convey the same or similar meanings. For example, “channels” and/or “symbols” may be replaced by “signals” (or “signaling”). Also, “signals” may be “messages.” Furthermore, “component carriers” (CCs) may be referred to as “cells,” “frequency carriers,” “carrier frequencies” and so on.

Also, the information and parameters described in this description may be represented in absolute values or in relative values with respect to a predetermined value, or may be represented by using other equivalent pieces of information. For example, radio resources may be specified by predetermined indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

Also, software and commands may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation and microwaves), these wired technologies and/or wireless technologies are also included in the definition of communication media.

The example s/embodiments illustrated in this description may be used individually or in combinations, and the mode of may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the example s/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, broadcast information (MIBs (Master Information Blocks) and SIBs (System Information Blocks)) and MAC (Medium Access Control) signaling and so on), other signals or combinations of these. Also, RRC signaling may be referred to as “RRC messages,” and can be, for example, an RRC connection setup message, RRC connection reconfiguration message, and so on.

The examples/embodiments illustrated in this description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the example s/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-218002, filed on Nov. 5, 2015, including the specification, drawings and abstract, is incorporated herein by reference in its entirety.

1. A user terminal comprising:
a measurement section that performs an inter-frequency measurement based on one measurement gap configuration; and
a control section that controls whether or not to perform the inter-frequency measurement in a predetermined measurement gap.

2. The user terminal according to claim 1, wherein the control section controls whether or not to perform the inter-frequency measurement based on predetermined downlink control information.

3. The user terminal according to claim 2, wherein the predetermined downlink control information includes information that indicates whether the measurement gap is valid or invalid.

4. The user terminal according to claim 3, wherein, when a signal is transmitted in the predetermined measurement gap in at least one of a serving carrier with which the user terminal is connected and a carrier being a target of the inter-frequency measurement, the information to indicate whether the measurement gap is valid or invalid indicates that the measurement gap is invalid.

5. The user terminal according to claim 2, wherein the predetermined downlink control information includes information about a length of the measurement gap and/or information about offset of the measurement gap.

6. The user terminal according to claim 2, wherein, when at least one of transmission and receipt of data is scheduled in the predetermined measurement gap, the control section controls to skip the inter-frequency measurement in the predetermined measurement gap.

7. The user terminal according to claim 6, wherein the control section controls to perform the inter-frequency measurement in a measurement gap that appears after the inter-frequency measurement is skipped a predetermined number of times in a row.

8. The user terminal according to claim 1, wherein, based on information about a measurement period of a predetermined carrier being a target of the inter-frequency measurement, the control section controls whether or not to perform the inter-frequency measurement for the predetermined carrier in the predetermined measurement gap.

9. A radio base station comprising:
a transmission section that transmits control information, including at least one measurement gap configuration, to a user terminal; and
a receiving section that receives a result of an inter-frequency measurement based on the measurement gap configuration,
wherein whether or not the inter-frequency measurement can be executed in a predetermined measurement gap is controlled in the user terminal.

10. A radio communication method comprising:
performing an inter-frequency measurement based on one measurement gap configuration; and
controlling whether or not to perform the inter-frequency measurement in a predetermined measurement gap.

11. The user terminal according to claim 3, wherein the predetermined downlink control information includes information about a length of the measurement gap and/or information about offset of the measurement gap.

12. The user terminal according to claim 4, wherein the predetermined downlink control information includes information about a length of the measurement gap and/or information about offset of the measurement gap.
